(19) United States
(12) Patent Application Publication
(10) Pub. No.: US 2003/0026495 A1
(43) Pub. Date: Feb. 6, 2003

(54) Parameterized sharpening and smoothing method and apparatus

(76) Inventors: Jay Stephen Gondek, Camas, WA (US); Amanda Jean Gillihan, Vancouver, WA (US); C. Brian Atkins, Mountain View, CA (US)

Correspondence Address: HEWLETT-PACKARD COMPANY, Intellectual Property Administration, P.O. Box 272400, Fort Collins, CO, 80527-2400, US

(21) Appl. No.: 10/136,958

(22) Filed: May 1, 2002

Related U.S. Application Data
(63) Continuation-in-part of application No. 09/800,638, filed on Mar. 7, 2001.

(51) Int. Cl. G06K 9/40; G06T 5/00; G06K 9/56; G06K 9/46

(52) U.S. Cl. 382/261; 382/205; 382/199; 382/226

(57) ABSTRACT

Provided is a method and apparatus of processing an image using filters. The method and apparatus receives an input pixel and a pixel window associated with the input pixel from the image, classifies the input pixel using the pixel window into a range of classes identifying pixels suitable for various degrees of smoothing and sharpening operations, receives parameter independently set for sharpening and smoothing the image, and selects a filter for processing the input pixel based upon the pixel classification and the parameter settings for sharpness and smoothness.

### CROSS REFERENCE TO RELATED APPLICATIONS

This application is a continuation-in-part of Docket Number 10004248-1, application Ser. No. 09/800,638 of Atkins et al., filed Mar. 7, 2001 entitled ”Digital Image Appearance, Enhancement and Compressibility Improvement Method and System” assigned to the assignee of the present invention and incorporated by reference herein for all purposes.

This application relates to Docket Number 100111292-1, U.S. Patent Application Docket Number 100111292-1, Ser. No. ______ of ______ filed May 1, 2002 entitled “Method And Apparatus For Associating Image Enhancement With Color” filed on the same day therewith, assigned to the assignee of the present invention and incorporated by reference herein for all purposes.

### BACKGROUND OF THE INVENTION

The proliferation of digital image photography, printing and image generation demands improved image processing techniques. These image processing techniques improve the perceived quality of images by manipulating the data captured and recorded by cameras and other devices. Lower cost devices can produce higher quality images through sophisticated image processing techniques performed on computers and peripheral devices. This satisfies the consumer's need for better quality images without spending large amounts of money for professional or even ”prosumer⇄ type devices.

One image processing technique called image-sharpening tends to improve the overall details in an image. Typically, image-sharpening operates by increasing pixel contrast on and around perceived edges in an image. If the edges are important to the image, this increases the visible details in the image and overall perceived quality of the image. Unfortunately, artifacts, noise and other details may not be desired yet will also be enhanced by image-sharpening operations. These sharpening operations can often make the image look “noisy” and appear of lower quality than if otherwise left alone.

Alternative image processing operations for smoothing operate to reduce or eliminate artifacts, noise and other undesired detailed elements of an image. Filters and other operations are applied to these images to soften or eliminate details perceived to be artifacts and noise. Smoothing preferably eliminates unwanted noise and artifacts by making neighboring pixels more consistent with each other. Applied indiscriminately, these filters have the deleterious effect of also eliminating desired details important to the image and can result in fuzzy or blurred images.

Active suppression of noise and artifacts during image processing is another method of improving image quality through image processing. These operations also have a smoothing effect primarily on or around sharp edges in an image. While these suppression methods may be more accurate, they can be computationally inefficient and therefore not cost effective to implement on lower cost hardware and software platforms.

Moreover, even high quality image processing methods cannot be applied successfully to all types of images. An image processing method that improves one image may be inappropriate when applied to another image. Further, one image processing technique may counteract the advantageous effects of another image processing technique.

### BRIEF DESCRIPTION OF THE DRAWINGS

FIG. 1 is a block diagram illustrating an overall method and system of processing images in accordance with one implementation of present invention;

FIG. 2 is a flowchart diagram providing the operations associated with creating an image processing system in accordance with implementations of the present invention;

FIG. 3 is a diagram illustrating parameterized image enhancement controls in one implementation of the present invention;

FIG. 4 is a table diagram identifying a set of filters used by one implementation of the present invention to smooth and sharpen pixels in an image;

FIG. 5A-C are flowchart diagrams identifying the operations associated with classifying pixels in an image in accordance with one implementation of the present invention and further detailing operations in FIG. 2;

FIG. 6 is filter selection table for organizing a number of filters and enhancement settings for smoothing and sharpening in accordance with one implementation of the present invention; and

FIG. 7 is a block diagram representation of an image processing apparatus 700 for image processing in accordance with one implementation of the present invention. Like reference numbers and designations in the various drawings indicate like elements.

### DETAILED DESCRIPTION

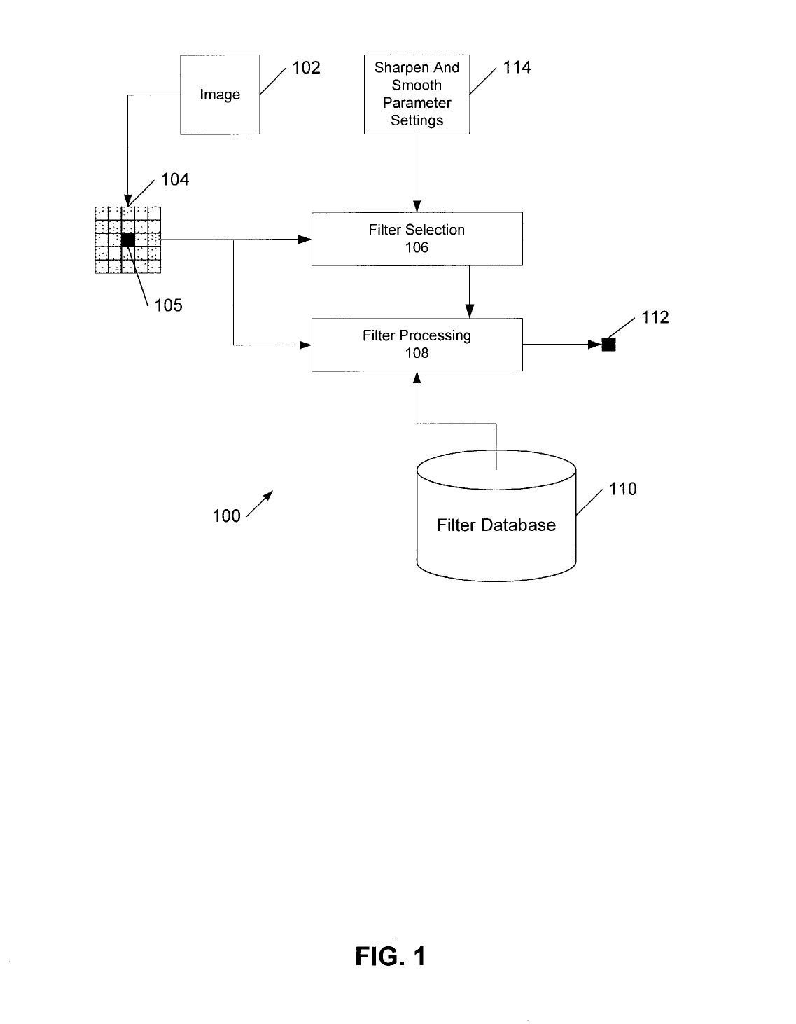

FIG. 1 is a block diagram illustrating an overall method and system of processing images in accordance with one implementation of present invention. Processing image 102 involves a pixel window 104, an input pixel 105, a filter selection module 106, a filter processing module 108, a filter database 110 and an output pixel 112 and parameterized enhancement settings 114.

In one implementation, image 102 is processed in sections using pixel window 104 having N×N pixels. Alternate implementations can include asymmetric pixel windows with M×N pixel dimensions. In the former arrangement, pixel window 104 dimensions can be set to 5×5, 3×3 and other window dimensions depending on the granularity of processing required. Filter selection module 106 analyzes pixel window 104 and input pixel 105 and classifies the pixel for different types of image enhancement. Further, filter selection module 106 also considers parameterized enhancement settings 114 when determining the degree of enhancement to perform. Smoothing and sharpening enhancement settings are set independently by a user using a user interface or automatically through some mechanism in a device or software. These parameterized settings along with the pixels being processed influence the type of image enhancement performed. Because the enhancement settings are parameterized, sharpening and smoothing type image enhancements can be set differently depending on the output image desired.

For example, smoothing may be performed on input pixel 105 if pixel window 104 includes noise and the smoothing parameter from parameterized enhancement setting 114 is set relatively high compared with the sharpening parameter. Filter selection information is passed to filter processing module 108 and used to access the appropriate filter or filters from filter database 110. Filter processing continues shifting arrays of pixels from image 102 into in pixel window 104 until image 102 has been enhanced.

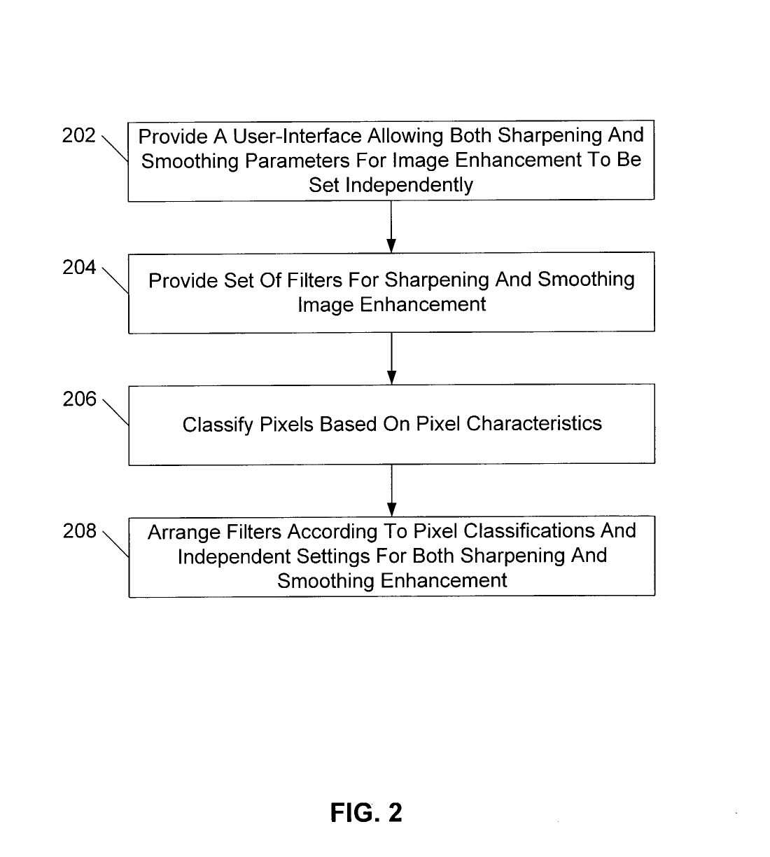

Image processing according to one aspect of the present invention includes creating a system with the proper interfaces and access to the filters for image enhancement. FIG. 2 is a flowchart diagram providing the operations associated with creating an image processing system in accordance with implementations of the present invention. An interface allowing both sharpening and smoothing parameters to be set independently provides flexibility for a user or application processing images using an implementation of the present invention (202). For example, a user-interface can be set in the device-driver area of an operating system that interfaces with an image processing device designed in accordance with the present invention. Alternatively, the user-interface can be somewhere within the application layer or in a combination of both the device-driver area of the operating system and the application layer. Setting the sharpening and smoothing parameters can be done to emphasize one image enhancement process over another. To emphasize smoothing over sharpening processing of an image, the user or application would increase the smoothing enhancement parameter and reduce the sharpening setting for the sharpening parameter. Conversely, to emphasize the sharpening over the smoothing image type of image enhancement, the user or application would increase the sharpening enhancement parameter rather than the smoothing enhancement parameter.

A set of filters for sharpening and smoothing the image are also included in the image processing system in accordance with implementations of the present invention (204). In one implementation, 13 precomputed filters are stored in filter database 110 covering multiple levels of smoothing and sharpening as needed for processing various types of images. Various types of precomputed sharpening and smoothing filters are compatible with the present invention. Often, the precomputed filter is a collection of numerical coefficient values used as a linear filter. These coefficient values are multiplied by corresponding pixel values in a pixel array and the resulting products are summed together. In addition to these linear filters, those skilled in the art can appreciate that other types of filters may be used, such as adaptive filters whose coefficient values change depending on the input data.

Before applying image processing to a pixel, input pixel 105 and pixel window 104 are analyzed and classified for proper enhancement (206). For example, input pixel 105 is classified into classes for noise, high-frequency detail and various directional edges. These classification determinations are made by performing different matrix operations on pixel window 104 and comparing the results with various threshold levels.

The parameterized enhancement settings for sharpening and smoothing are associated with the various filters for smoothing and sharpening in a multidimensional table or storage area (208). Different filters are used to enhance pixels in an image on a pixel by pixel basis. Applying a smoothing or sharpening filter depends on not only the classification for the pixel but also the parameterized enhancement settings. The image processing enhancement is effective and computationally efficient as the filters applied to different areas of the image depend on the type of pixel as well as the degree of smoothing or sharpening requested. Smoothing filters are applied to those areas of an image with artifacts and noise, while in other areas of an image the sharpening filters are applied to bring out edges and details.

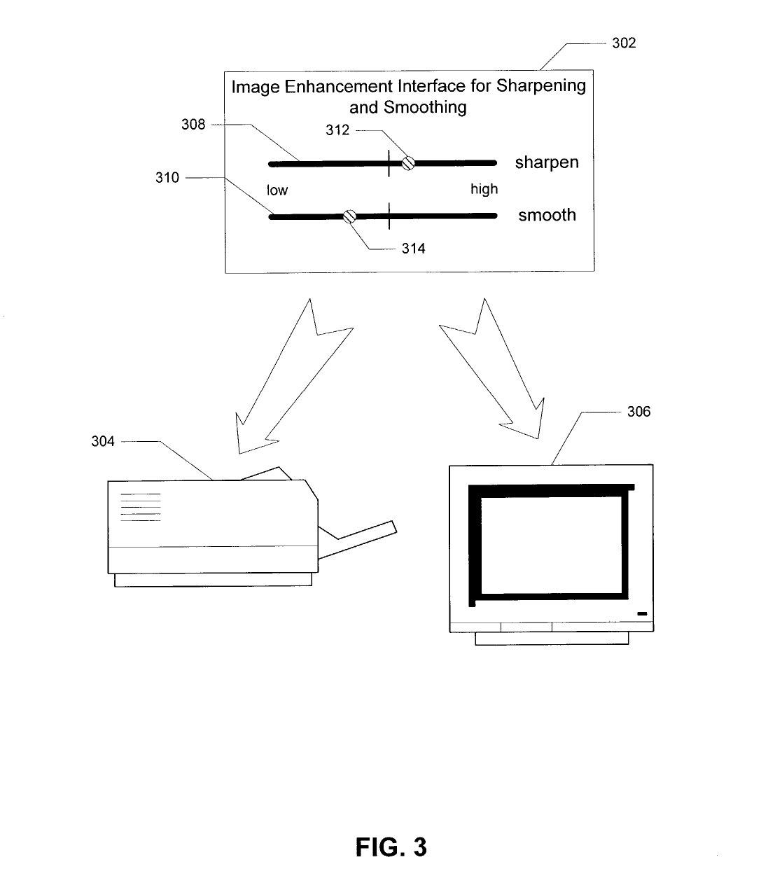

FIG. 3 is a diagram illustrating parameterized image enhancement controls in one implementation of the present invention. Sharpening and smoothing settings are set independently using parameterized image enhancement controls 302. In this example, sharpening slider 308 sets the parameter for sharpening pixels in an image while smoothing slider 310 sets the parameter for smoothing pixels in the same image. The user or application sets parameterized image enhancement controls 302 to indirectly control the degree of sharpening or smoothing when rendering images on either a printer device 304, a display device 306 or any other type of device that provides visual images or data. Parameter settings for the smoothing and sharpening image enhancements are used in accordance with the present invention to select the proper filters as described in further detail later herein.

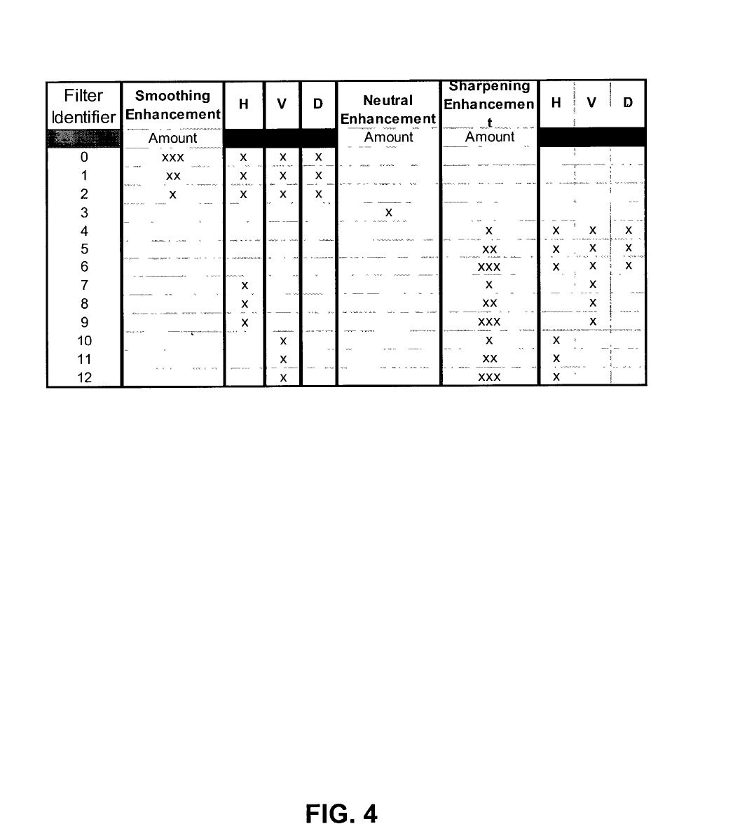

FIG. 4 is a table diagram identifying a set of filters used by one implementation of the present invention to smooth and sharpen pixels in an image. This particular table identifies different amounts of sharpening and smoothing provided by the 13 filters numbered 0 through 12. Filter 0, 1, and 2 provide smoothing enhancement to an image in decreasing amounts. For example, filter 2 provides the least amount of smoothing enhancement to pixels while filter 1 and filter 0 enhance pixels with increasing degrees of smoothing. Filter 3 is a pass-through filter that neither sharpens nor smoothes pixels and instead preserves high-frequency detail in the image. This filter is of particular importance in images with sand, bushes and other similar details that have high-amounts of activity that is not noise or image processing artifacts.

Sharpening enhancement is performed on different orientation edges and to differing degrees of enhancement. In this implementation, isotropic filters 4, 5 and 6 provide three increasing degrees of sharpness enhancement on diagonal edges. Filters 7,8 and 9 provide increasing amounts of sharpening enhancement on vertical edges. Finally, filters 10, 11 and 12 sharpen pixels along horizontal edges also with increasing degrees of sharpening.

In one implementation of the present invention, filters designed to sharpen in one orientation also smooth pixels along an orthogonal direction. For example, a horizontal filter designed in accordance with the present invention enhances edges along a vertical transition and smooths pixels in the flat horizontal direction. This emphasizes the edge in the detected direction while reducing noise and other artifacts not identified as an edge in the image. Similarly, a vertical filter enhances edges along a horizontal transition and smooths pixels in the vertical direction. Unlike the horizontal and vertical filters, the filters designed to sharpen on the diagonal edges also tend sharpen in the horizontal and vertical edges as well as indicated in FIG. 4.

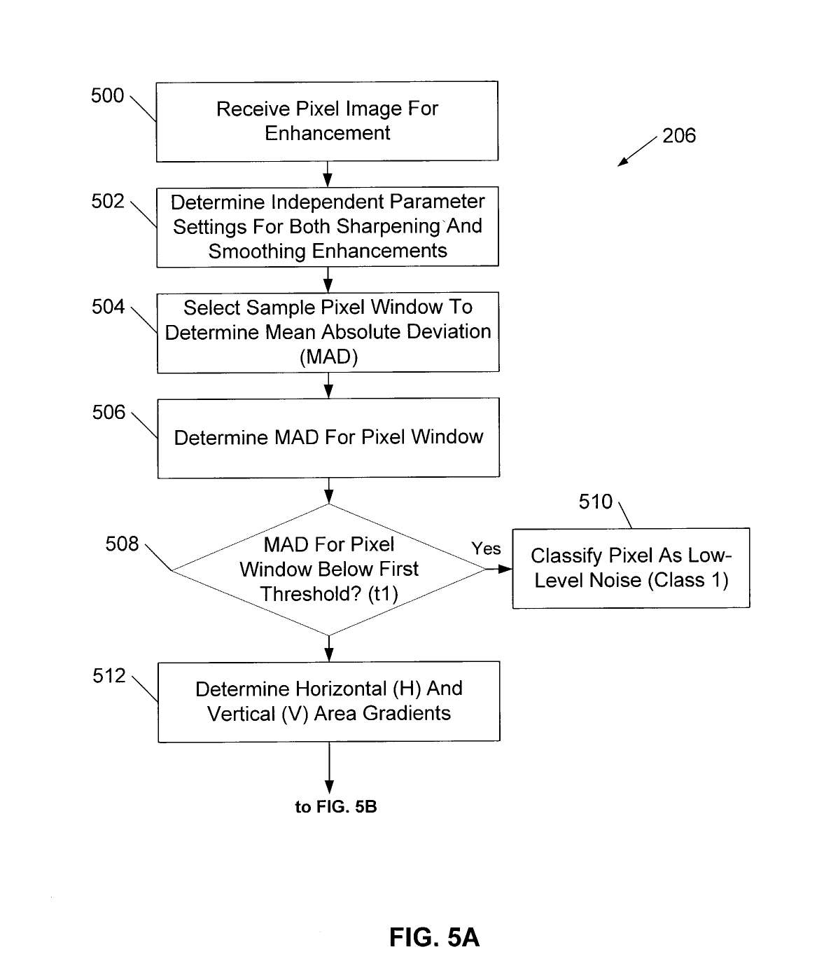

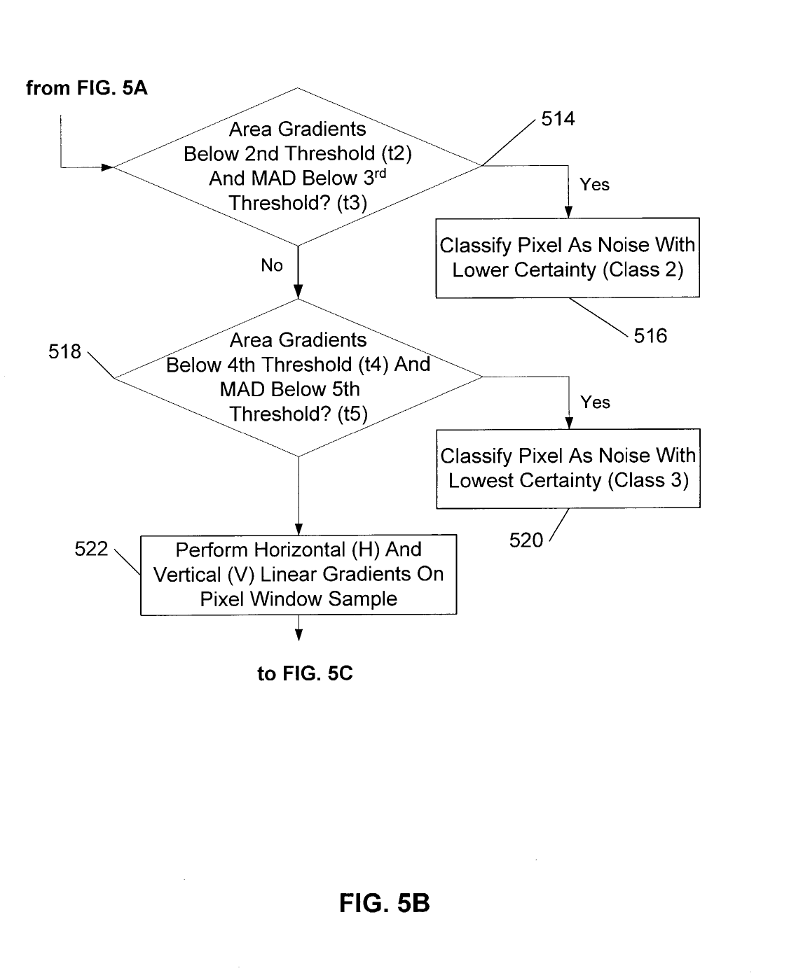

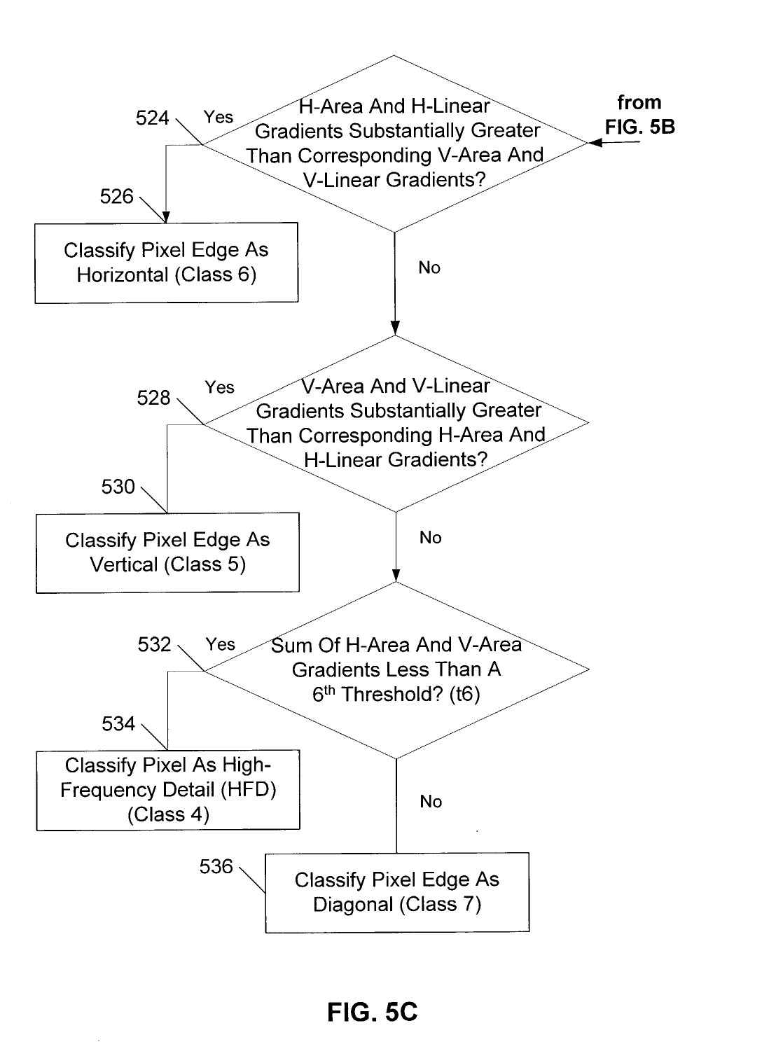

FIG. 5A-5C is a flowchart diagram identifying the operations associated with classifying pixels in an image in accordance with one implementation of the present invention and further details operation 206 referred to in FIG. 2. In FIG. 5A, the pixel classification process receives an image to be enhanced (500). In one implementation, the classification operates on one input pixel and an associated pixel window identified within the image for analysis. Each resulting classification and enhancement operation modifies the input pixel while updating an output image and shifting the sample pixel window to cover another area of image being enhanced. Eventually, classification information derived from the operations in FIG. 5A is used in conjunction with enhancement operations on the input image to create an enhanced output image of the same dimensions.

Parameter settings for both sharpening and smoothing can be set by a user or the application independently assisting in the filter selection and image enhancement decisions (502). The user or application sets sharpening and smoothing parameter settings in the device driver area or within an application to influence the degree of corresponding enhancement done on an image or group of images being processed. While the parameterized settings are set independently, implementations of the present invention interpret the settings for sharpening and smoothing and select appropriate enhancement filters in light of the classification for the given pixel. The parameterized settings allow the user to change settings easily as well as provide greater control over the type and degree of image enhancement performed.

In one implementation, the input pixel is in the center of a pixel window having either a 5×5 dimension or a smaller 3×3 dimension. Using a smaller pixel window allows the processing to occur more rapidly while the large pixel dimension trades processing time for increased precision . The input pixel and pixel window combination are used in conjunction when determining the degree of pixel-to-pixel variation or deviation within the pixel window (504). The level of variation indicates the degree of activity within the area covered by the pixel window and assists in identifying and classifying the pixel type.

Mean Average Deviation (MAD) is one metric for comparing the level of variation as between an input pixel and a selected pixel window (506). In a color image, MAD is calculated for each color plane of red (R), blue (B) and green (G) or analogous planes in alternate colorspaces. The MAD for the R, B and G planes are referred to as rMAD, bMAD and gMAD respectively. Alternatively, non-color images use a MAD calculation suitable for use with grayscale or other non-color representations of an image. In general, the present invention is not limited to either color or non-color images; instead MAD or other calculations can be adapted to work with color, grayscale or other schemes used in image reproduction and representation. It is also understood that various aspects of the present invention may be adapted to work with different colorspace, grayscale or other image representations.

For example, the rMAD for a 5×5 dimension red color plane is calculated initially by determining the coordinate values of the red color plane and the corresponding intensity values. The coordinates associated with the pixels of a 5×5 pixel window in the red color plane can be identified as the follows:

| | | | | |
|---|---|---|---|---|
| RI(−2, −2) | RI(−2, −1) | RI(−2, 0) | RI(−2, 1) | RI(−2, 2) |
| RI(−1, −2) | RI(−1, −1) | RI(−1, 0) | RI(−1, 1) | RI(−1, 2) |
| RI(0, −2) | RI(0, −1) | RI(0, 0) | RI(0, 1) | RI(0, 2) |
| RI(1, −2) | RI(1, −1) | RI(1, 0) | RI(1, 1) | RI(1, 2) |
| RI(2, −2) | RI(2, −1) | RI(2, 0) | RI(2, 1) | RI(2, 2) |

Where R(0,0) is the red coordinate value of the input pixel, and the red MAD for rMAD is computed as:

$$rMAD = {\sum }_{m = - 1}^{1} {\sum }_{n = - 1}^{1} \vert RI ( m , n ) - rAVE \vert$$

where one implementation of rAVE is a 3×3 pixel average computed as:

$$rAVE = ⌊ \frac{1}{9} ( 4 + {\sum }_{m = - 1}^{1} {\sum }_{n = - 1}^{1} RI ( m , n ) ) ⌋$$

and └┘ denotes truncation to integer. Although rMAD is described as a “mean absolute deviation” the value associated with rMAD is actually nine times greater than the corresponding value computed using the actual mean absolute deviation calculations. For the green and blue components, gMAD and bMAD are computed in a similar manner using the green and blue components respectively from a given image and normalized for comparison purposes according to their perceived contribution to color variation. To set up rMAD, gMAD and bMAD for comparisons, we determine which color component has the greatest impact on perceived variation in the vicinity of the input pixel. Because luminance variation is a reasonable predictor of perceived color variation, the magnitudes of rMAD, gMAD, and bMAD are scaled according to their approximate relative contributions to the luminance component. To see that scaling rMAD by one half and bMAD by one quarter achieves the desired objective, consider that the luminance Y for an (R, G, B) pixel is often computed as

Y=0.299*R+0.587*g+0.114*B,

and observe that 0.299 is approximately half of 0.587, and that 0.114 is approximately one quarter of 0.587. One desirable consequence of this is that it renders rMAD, gMAD, and bMAD all comparable to the same threshold value and the calculations provided herein can be readily applied to each color dimension in the RGB color space.

In an alternate implementation, MAD for images in grayscale and other non-color representations can be calculated in a correspondingly similar manner. It is contemplated that appropriate calculations for both color (e.g., RGB, CYMK or others) and non-color representations done in grayscale or other formats can be made as needed by the various implementations of the present invention.

Placing the input pixel into one of a range of classes determines the suitable amounts of smoothing and sharpening operations to apply. In one implementation, MAD is determined for the pixel window (506) and compared with a first threshold (t1) (508). If the MAD for the selected pixel is below the first threshold (t1) then the input pixel is classified in Class 1 as containing low-level noise (510). An input pixel classified as low-level noise is generally a candidate for a smoothing filter to reduce image artifacts and unwanted noise in the image. Because the variation of the input pixel compared with the pixel window does not exceed the first threshold (t1), the input pixel classification as low-level noise is made with a high degree of confidence.

If low-level noise is not detected based on the MAD, the horizontal (H) and vertical (V) area gradients (512) are calculated to help determine the degree of confidence that the input pixel is noise or, alternatively, an edge.

In one implementation illustrated in FIG. 5B, the input pixel is classified in Class 2 as low-level noise with lower certainty (514) when both the horizontal and vertical area gradients are below a 2^{nd} threshold and the MAD is below a 3^{rd} threshold (516). There is a lower confidence that the input-pixel represents low-level level noise in the image in part because the relatively higher MAD indicates an area with potential edges.

The input pixel is further classified in Class 3 as low-level noise (518) with even lower certainty when both the horizontal and vertical area gradients are below a 4^{th} threshold and the MAD is below a 5^{th} threshold (520). In one implementation of the present invention, the 4^{th} and 5^{th} threshold levels are greater than the corresponding threshold levels (i.e., 2^{nd} and 3^{rd} thresholds) previously described above in the classification process. The input pixels meeting this criteria area classified in Class 3 as being noise with even lower certainty and more likely to contain edges, high-frequency detail (HFD) or other important information to be left in the image and not smoothed.

An additional horizontal (H) and vertical (V) linear gradient are computed to further identify edges and their orientation in the image (522). Linear gradients are implemented as narrow horizontal and vertical gradients made along a series of pixels passing through the input pixel in the center of the pixel window. By using the linear gradient, details found in fonts and other fine image details are detected even when using larger 5×5 pixel windows to process an image. These linear gradients help make the classification process more accurate for finer detail images.

In FIG. 5C, both horizontal area and horizontal linear gradients are compared with corresponding vertical area and vertical linear gradients (524). If both the horizontal gradient components are greater than the corresponding vertical gradient components, the input pixel is classified in Class 6 as a horizontal pixel edge (526). Alternatively, the vertical area and vertical linear gradients are compared with corresponding horizontal area and horizontal linear gradients (528). If both the vertical gradient components are greater than the corresponding horizontal gradient components, the input pixel is classified in Class 5 as a vertical pixel edge (530).

If the input pixel remains unclassified, the sum of the horizontal area gradient and the vertical area gradient is compared with a 6^{th} th threshold (t6) (532). This determines if the input pixel is high-frequency detail (HFD) or a diagonal edge. If the sum of the gradients is less than the 6^{th} threshold, the input pixel is classified as high-frequency detail and classified as Class 3 (534). High-frequency details typically exhibit a high level of activity like noise yet contain detailed portions of an image typically better represented without enhancement. Some high-frequency detail areas including sand, bushes and other complex patterns. Class 7 is an alternate classification for the input pixel (536) when the sum of the gradients (532) is greater than or equal to the 6^{th} threshold (532). Class 7 is reserved for input pixels along diagonal edges in the image.

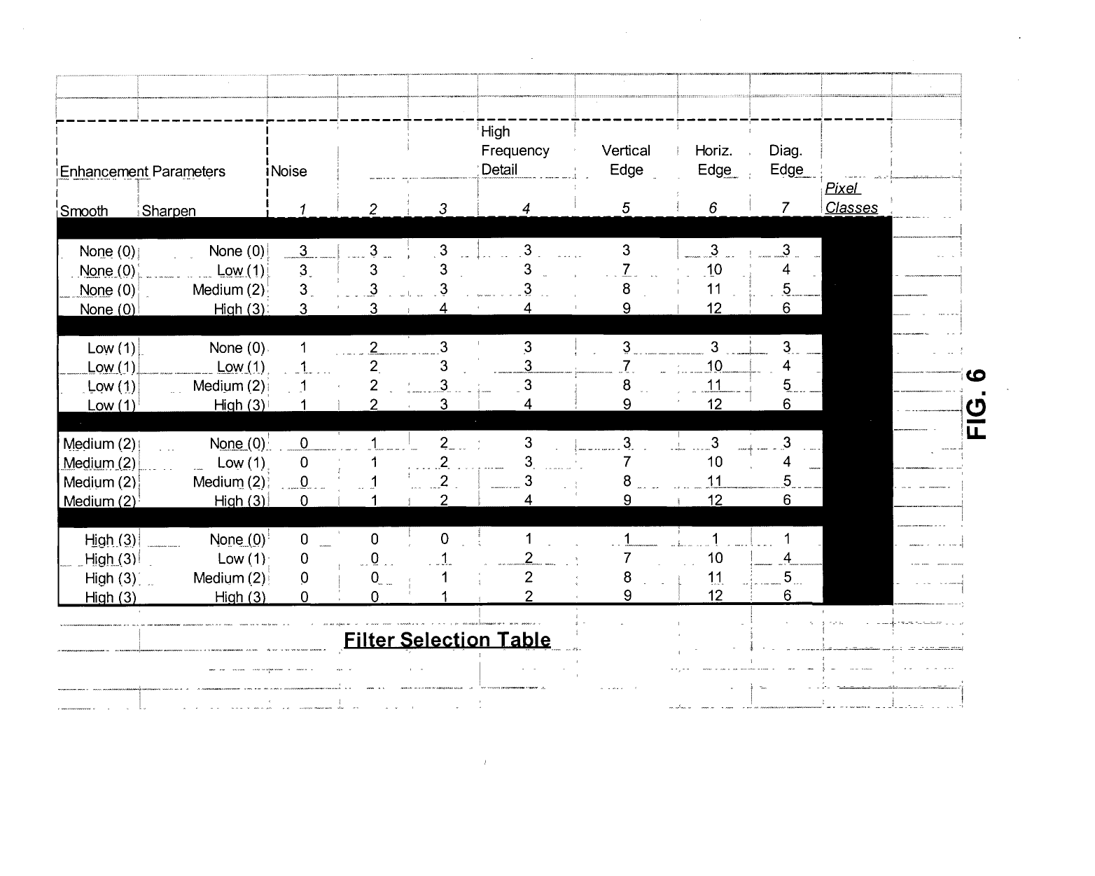

FIG. 6 is a filter selection table for organizing a number of filters and enhancement settings for smoothing and sharpening in accordance with one implementation of the present invention. In this implementation, sharpening and smoothing are the enhancement parameters a user or application sets to influence the image processing of an image. Both the sharpening and smoothing enhancement parameters in FIG. 6 are identified in columns 1-2 and can be independently set to permutations of none (0), low (1), medium (2) and high (3).

Each sharpening and smoothing parameter setting has a row of filters in table in FIG. 6 corresponding to each class of input pixel being processed. Filters in the table are selected that best suit the enhancement parameter settings and the class of pixel being processed. For example, setting both smoothing and sharpening parameters to none (0) and none (0) causes filter “3” to be applied to all pixel classes 1-7. Filter “3” is a pass-through filter suggested in this row because the parameter settings specify no enhancement activity during image processing. Further, setting smoothing to none (0) and sharpening to high (3) causes a sharpening filter “12” to be applied to a Class 6 pixel classified as a horizontal edge. It is also interesting to note that pixels Classified as High-frequency detail (HFD) often have a pass-through filter like filter “3” to preserve the details and not smooth or sharpen.

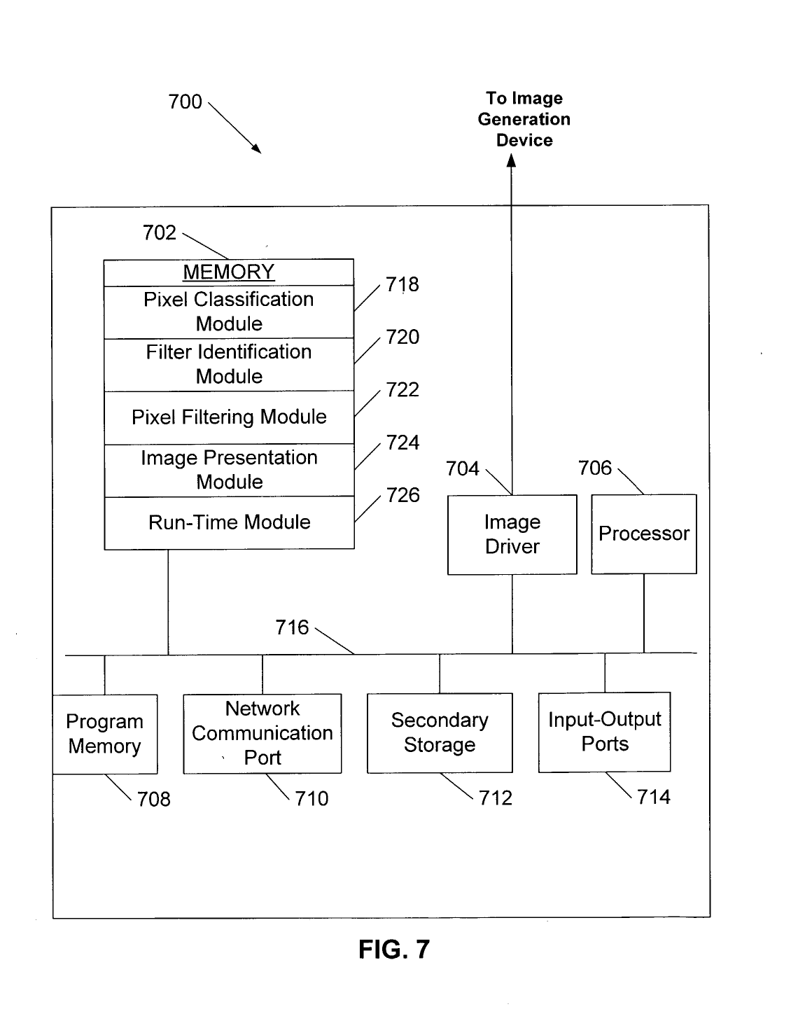

FIG. 7 is a block diagram representation of an image processing apparatus 700 for image processing in accordance with one implementation of the present invention. In this example, image processing apparatus 700 includes a primary memory 702, an image driver 704, a processor 706, a program memory 708, a network communication port 710, a secondary storage 712, and input-output ports 714.

Image processing apparatus 700 can be included as part of a computer system or can be designed into one or more different types of peripheral equipment. In a computer system, image processing apparatus 700 receives graphics from an application and enhances the images in accordance with the present invention. Software and controls used by image processing apparatus 700 may reside in the application, in device drivers, in the operating system or a combination of these areas depending on the implementation design requirements. Alternatively, if image processing apparatus 700 is part of a peripheral device like a printer or display, images could be enhanced without depending entirely on the processing requirements of a computer. This would enable, for example, a stand alone network attached image generation device to process and enhance image in accordance with the present invention without relying on the concurrent availability of a personal computer or similar computing device. For example, a network attached printer device could receive images over a network and process the images in accordance with the present invention. Implementations of the present invention could be installed or built into a single network attached peripheral device providing enhanced images without requiring upgrade of applications, operating system or computer devices throughout the network.

Primary memory 702 stores and retrieves several modules for execution by processor 706. These modules include: a pixel classification module 718, a filter identification module 720, a pixel filtering module 722, an image presentation module 724 and a runtime module 726. The pixel classification module 718 processes the pixels and determines the class the pixel should be based on MAD, gradients and other factors as described above.

Filter identification module 720 receives pixel classification information, enhancement parameter settings and selects the proper filter from a filter table for use in processing input pixels in an image. In one implementation, filter identification module 720 can also store the actual filters being used to filter input pixels; alternatively, these filters can be accessed in a database (not shown) and identified by filter identification module 720 using a pointer or index into the storage area. The number and type of filters used by filter identification module 720 can be increased in number or modified as needed over time. They can also be updated dynamically along with transmitted images if special filters are required to process certain types or classes of images with special image processing requirements.

Pixel filtering module 722 applies the selected filters to the pixel or pixels from an image. The resulting pixels passing through pixel filtering module 722 are enhanced using sharpening and smoothing techniques in accordance with one implementation of the present invention. Image presentation module 724 sends a block or stream of image data, including the enhanced pixels, over bus 716 and onto image generation device for display, printing or other visual representation. Additional functions in image presentation module may include data buffering, compression, encryption and other image processing operations. Run-time module 726 can be a real-time executive or operating system or conventional preemptive operating system that coordinates the allocation of resources, operation and processing on image processing device 700.

Image driver 704 interfaces with one or more different types of image generation devices providing signal and protocol level communication suitable for communication with the particular device.

Processor 706 can be a general purpose processor that executes x86 instructions or similar general purpose instructions. Alternatively, processor 706 can be an embedded processor that executes instructions burned into ROM or microcode depending on the implementation requirements.

Program memory 708 provides additional memory for storing or processing instructions used by processor 706. This area may operate as a primary area to execute instructions or as an additional cache area for storing frequently used instructions or macro-type routines.

Network communication port 710 provides network connectivity directly with image processing device 700. This port can provide high-speed network access using protocols like TCP/IP or can provide dial-up serial access over a modem link using serial network protocols like PPP, SLIP or similar types of communication for communication or diagnostics purposes.

Secondary storage 712 is suitable for storing executable computer programs, including programs embodying the present invention, and data used by the present invention. This area can be a traditional memory or solid-state memory storage.

Input/output (I/O) ports 714 are coupled to image processing device 700 through bus 716. Input/output ports 714 facilitate the receipt and transmission of data (e.g., text, images, videos, and animations) in analog or digital form over other types of communication links such as a serial link, local area network, wireless link, and parallel link. Input/output (I/O) ports 612 facilitate communication with a wide variety of peripheral devices including keyboards, pointing devices (mouse, touchpad and touchscreen) and printers. Alternatively, separate connections (separate buses) can be used to interface with these peripheral devices using a combination of Small Computer Systems Interface (SCSI), Universal Serial Bus (USB), IEEE 1394/Firewire, Personal Computer Memory Card International Association (PCMCIA) or any other suitable protocol.

In practice, the invention can be implemented in digital electronic circuitry, or in computer hardware, firmware, software, or in combinations of them. Apparatus of the invention can be implemented in a computer program product tangibly embodied in a machine-readable storage device for execution by a programmable processor; and method steps of the invention can be performed by a programmable processor executing a program of instructions to perform functions of the invention by operating on input data and generating output. The invention can be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object-oriented programming language, or in assembly or machine language if desired; and in any case, the language can be a compiled or interpreted language. Suitable processors include, by way of example, both general and special purpose microprocessors. Generally, a processor will receive instructions and data from a read-only memory and/or a random access memory. Generally, a computer will include one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing can be supplemented by, or incorporated in, ASICs (application-specific integrated circuits).

While specific embodiments have been described herein for purposes of illustration, various modifications may be made without departing from the spirit and scope of the invention. Accordingly, the invention is not limited to the above-described implementations, but instead is defined by the appended claims in light of their full scope of equivalents.

What is claimed is:

1. A method of processing an image with filters, comprising:
receiving an input pixel and a pixel window associated with the input pixel from the image;
classifying the input pixel using the pixel window into classes identifying pixels suitable for various amounts of smoothing and sharpening operations;
receiving parameter settings for sharpening and smoothing the image, wherein the sharpening and smoothing parameters can be set independently; and
selecting a filter for processing the input pixel based upon the classification and the parameter settings.

2. The method of claim 1 wherein the input pixel is classified for smoothing when a variation of the input pixel compared with the pixel window does not exceed a predetermined threshold of variation.

3. The method of claim 2 wherein the variation is determined according to a mean average deviation of the input pixel computed using the pixel window.

4. The method of claim 1 wherein the input pixel is classified for sharpening when a variation of the input pixel exceeds a predetermined threshold of variation and edges are detected within the pixel window.

5. The method of claim 4 wherein the edges are detected using one or more gradients.

6. The method of claim 1 wherein the parameter settings for smoothing and sharpening an image can be independently set through a user-interface in an application.

7. The method of claim 1 wherein the parameter settings for smoothing and sharpening an image can be independently set through a user-interface in a device driver.

8. The method of claim 1, wherein the filter is selected from a set of filters including at least one smoothing filter, at least one sharpening filter and at least one a passthrough filter.

9. The method of claim 3, wherein the mean absolute deviation is calculated using the sum of the differences between an input pixel value and a pixel window average.

10. An apparatus for processing an image, comprising:
a pixel storage area that receives an input pixel and a pixel window associated with the input pixel from the image;
a pixel classification module that classifies the input pixel using the pixel window into classes identifying pixels suitable for various amounts of smoothing and sharpening operations;
a storage area that receives parameter settings for sharpening and a smoothing to control the degree of sharpening and smoothing image enhancement, wherein the degree sharpening and smoothing parameters can be set independently by parameters; and a selection module that selects a filter for processing the pixel based upon the pixel classification and the parameter settings for sharpness and smoothness.

11. The apparatus of claim 10 wherein the pixel classification module classifies the pixel for smoothing when the variation level of the input pixel compared with the pixel window does not exceed a predetermined threshold of variation.

12. The apparatus of claim 11 wherein the variation is determined according to a mean absolute deviation (MAD) of the input pixel computed using the pixel window.

13. The apparatus of claim 10 wherein the input pixel is classified for sharpening when the pixel variation exceeds a predetermined threshold of variation within the pixel window and edges are detected within the pixel window.

14. The apparatus of claim 13 wherein the edges are detected using one or more gradients against the pixel array.

15. The apparatus of claim 14 wherein the edges are further detected using one or more linear gradients.

16. The apparatus of claim 10 wherein the parameter settings for smoothing and sharpening an image can be independently set through a user-interface in an application.

17. The apparatus of claim 10 wherein the parameter settings for smoothing and sharpening an image can be independently set through a user-interface in a device driver.

18. A means for processing an image, comprising:
a means for receiving an input pixel and a pixel window associated with the input pixel from the image;
a means for classifying the input pixel using the pixel window into a range of classes identifying pixels suitable for various degrees of smoothing and sharpening operations; a means for storing the parameters that correspond to a sharpen parameter and a smooth parameter setting to control the degree of sharpening and smoothing in the image enhancement, wherein the sharpening and smoothing parameters can be set independently; and
a means for selecting a filter for processing the input pixel based upon the pixel classification and the parameter settings for sharpness and smoothness.

19. A computer program product, tangibly stored on a computer-readable medium, comprising instructions operable to cause a programmable processor to:
receive an input pixel and a pixel window associated with the input pixel from an image;
classify the input pixel using the pixel array into a range of classes identifying pixels suitable for various degrees of smoothing and sharpening operations;
store the parameters that correspond to a sharpen parameter and a smooth parameter setting to control the degree of sharpening and smoothing in the image enhancement, wherein the sharpening and smoothing parameters can be set independently; and
select a filter for processing the input pixel based upon the pixel classification and the parameter settings for sharpness and smoothness.

20. A system for processing images, comprising:
a processor that executes instructions for generating an image;
an image processing device that receives an input pixel and a pixel window associated with the input pixel from the image, classifies the input pixel using the pixel window into classes identifying pixels suitable for various degrees of smoothing and sharpening operations, stores the parameters that correspond to a sharpen parameter and a smooth parameter setting to control the degree of sharpening and smoothing in the image enhancement, wherein the sharpening and smoothing parameters can be set independently and selects a filter for processing the input pixel based upon the pixel classification and the parameter settings for sharpness and smoothness; and
an image generation device that receives one or more processed pixels in the image and processes them for visual presentation.

21. The system of claim 20 further comprising,
a storage device that stores routines containing instructions for execution on the processor.

22. The system of claim 21 wherein the visual presentation is done using a display device.

23. The system of claim 21 wherein the visual presentation is done using a printer device.

24. A method of creating an image processing system, comprising:
providing a user-interface facilitating the setting of parameters to determine the degree of sharpening and smoothing of an image;
receiving a set of filters that perform sharpening and smoothing image enhancement
classifying pixels types based on pixel characteristics; and
arranging the set of filters according to both the pixel characteristic classifications and each of the independent settings for sharpening and smoothing.

25. The method of claims 24 wherein the user-interface for setting the parameters is accessible through an application.

26. The method of claim 24 wherein the user-interface for setting the parameters is accessible through a device-driver.

27. The method of claim 24 wherein the user-interface allows the parameters for sharpening and smoothing to be set independently.

28. The method of claim 27 wherein the user-interface allows each parameter to be set to at least a low, medium or high setting.

29. The method of claim 24 wherein the set of filters includes precomputed linear filters constructed from numerical coefficient values multiplied by corresponding pixel values in a pixel array wherein the resulting products are summed together.

30. The method of claim 24 wherein the set of filters includes adaptive filters whose coefficient values change depending on the input data.

31. The method of claim 24 wherein the pixel characteristics used to classify the pixels comprises noise, high-frequency detail and edges having vertical, horizontal and diagonal qualities.

32. The method of claim 24 wherein the filters for sharpening are arranged to enhance pixels classified as having edges.

33. The method of claim 24 wherein the filters for smoothing are arranged to enhance pixels classified as having noise.

34. The method of claim 24 wherein the no filters are applied to pixels classified as having high-frequency detail.
